(19) United States
(12) Patent Application Publication
(10) Pub. No.: US 2018/0089161 A1
(43) Pub. Date: Mar. 29, 2018

(54) 360 Degree Patent Portfolio

(71) Applicant: PATENT21P LLC, Pleasanton, CA (US)

(72) Inventors: Tue Nguyen, Pleasanton, CA (US); Ferdinand Seemann, Pleasanton, CA (US); Tina Yan, Pleasanton, CA (US); Harrison Geron, Pleasanton, CA (US)

(21) Appl. No.: 15/715,253

(22) Filed: Sep. 26, 2017

Related U.S. Application Data
(60) Provisional application No. 62/399,501, filed on Sep. 26, 2016.

(51) Int. Cl. G06F 17/24; G06Q 50/18; G06T 11/20

(52) U.S. Cl. CPC G06F 17/246; G06T 11/206; G06Q 50/184

(57) ABSTRACT

This invention relates generally to a business method for displaying information. In one example embodiment, to methods, apparatus, and systems to easily display and present patents and intellectual property, along with associated data, within a graphic representation, preferably in a circular graphic, where the graphic aids in interpreting and understanding a plurality of data points quickly in any environment or presentation.

This application claims priority from U.S. Provisional Patent Application Ser. No. 62/399,501, filed on Sep. 26, 2016 entitled “360 Degree Patent Portfolio”, where applications are incorporated herein by reference in their entirety for all purposes.

### FIELD OF TECHNOLOGY

This disclosure relates generally to a business methods, methods, systems or apparatuses for displaying information. In one example embodiment, to business methods, methods, systems or apparatuses to easily display and present patents and intellectual property, along with associated data, within a graphic representation, preferably in a circular graphic.

### BACKGROUND

Within many fields, and most notably those within the fields that interact or deal with intellectual property and patents, patent attorneys, intellectual property advisers, consultants and many other various professionals of which whom have to quickly accurately, and thoroughly present intellectual property and patents held by an individual, company or entity. Most often patents and portfolios, among other asset types, require these presentations to happen over the computer such as in email communications and have to be self-explanatory and easy to follow. In other situations, the information is presented in person such as in a board meetings and in PowerPoint or some other display medium. For both the information must be easy, fast paced and requires as little time as possible to get the information over. These intellectual property and patent disclosures and information sessions may be for varied reasons such as in advisement for further intellectual property strategies, for mergers and acquisitions, company evaluations or any other disclosures or reasons and regularly include many, many elements such as patents, trademarks, or other intellectual property devices. With each element are many, many different data points such as dates of issue, date of allowances, dates of expiration, titles, categories, fields, inventor, among many, many other data points. It becomes clear then that with the amount of information exponentially grows with each patent, and it becomes harder and harder to describe quickly and efficiently the information necessary for one to make a decision or see the landscape of the intellectual property and patents.

Thus, there is a need within the intellectual property and patent fields for a system, business methods, methods, systems or apparatuses or apparatus such as a business method, method, system or apparatus for quickly, efficiently, and easily displaying many data points about many data entries, such as patents, in an easy to follow and understand display format, such that conclusions may be quickly drawn to enact in further business actions or relations.

### SUMMARY

Disclosed are business methods, methods, systems or apparatuses that provide a business methods, methods, systems or apparatuses for displaying information. In one example embodiment, to business methods, methods, systems or apparatuses to easily display and present patents and intellectual property, along with associated data, within a graphic representation, preferably in a circular graphic.

In a general sense, the present invention presents the ability to take multiple data entries, of which may have many data points about the data entries, and quickly and easily organize, present and convey the information. In the preferred embodiment, the data entries may be patents, or other pieces of intellectual properties such as trademarks or other documents. For each data entry, there may be any number of data points, of which may include, but are not limited to, application numbers, publication numbers, patent numbers, names, dates, titles, summaries, text, pictures, logos, inventor titles, assignees, or any other values or text which may describe the data entries and are worth noting or otherwise are may be important to those looking at the display. These data points may be automatically or manually sourced from any source, such as the USPTO web site, documentation, the internet, or any other business methods, methods, systems or apparatuses or source. In addition the information for the data points does not have to already exist but may at the time of the business methods, methods, systems or apparatuses be formulated or otherwise assigned, such as a new category that matches many of the data points but was not present with the data points themselves. In some embodiments, these may be a categorization or subset grouping of the data entries or data points.

With this information gathered then the information may be presented in a spreadsheet, chart or other business methods, methods, systems or apparatuses such as an Excel sheet, where the information then is organized and specific data points gathered may be presented in line, such as vertically or horizontally with each data entry. From there, special categorization, of which may be a value, such as a text or name, such as a category, or may be a color, or number may be assigned. Also, each data entry may also be given a designator, such as a value, color or shape. As well as this any number of designators may be assigned, and may be different in scope as well as be shared.

In a preferred embodiment, then the spreadsheet may be on a second page of a presentation, or a subset of the same page, and the main display, may be a 360 chart. The 360 chart may be described as circular, much like a radar screen with cross sections. Categories may be presented in a quadrant or other division of the circle. The data appoints then with a value, shape or color may then be placed in each quadrant, such that the data entry may be seen to be within each category by the designator. In addition to designators for each quadrant there may be any other plurality of designators or sub quadrants, that may be less or more specific than the firs mentioned designators, but also be of a different plane or scale than the first or other designations categories. This allows then the 360 chart to display more than simply a single designation or but provide for more degrees and types of categorizations simultaneously. This may then allow the chart to be efficient in displaying many different data points for many different data entries in different scopes.

The business method, method, system or apparatus and systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, in which, like references indicate similar elements.

FIG. 1 is a simple depiction of the present invention 360 diagram according to some embodiments.

FIG. 2 is a depiction of the present invention 360 diagram with presentation layout according to some embodiments.

FIG. 3 is a simple depiction an example spreadsheet list of data points presented on 360 diagram according to some embodiments.

FIG. 4 is a simple depiction an alternate example spreadsheet list of data points presented on 360 diagram according to some embodiments.

FIG. 5 is an example process for creating a 360 diagram according to some embodiments.

FIG. 6 is an example alternate process for creating a 360 diagram according to some embodiments.

FIG. 7 is an example spreadsheet list of data points with description area presented on 360 diagram according to some embodiments.

FIG. 8 is an example assessment description area presented on 360 diagram according to some embodiments.

FIG. 9 is an example recommendation description area presented on 360 diagram according to some embodiments.

FIG. 10A is an example process for creating a 360 diagram according to some embodiments.

FIG. 10B is an example process for creating a 360 diagram according to some embodiments.

Other features of the present embodiments will be apparent from the accompanying drawings and from the detailed description that follows.

### DETAILED DESCRIPTION

Disclosed are business methods, methods, systems or apparatuses that may provide an efficient and easily understood display such a business methods, methods, systems or apparatuses or system to easily display and present patents and intellectual property, along with associated data, within a graphic representation, such that one viewing may understand a holistic and thorough view and understanding of a given category or multiple categories in respect to intellectual property and patents.

In one embodiment, the information is preferably presented as a circular graphic style as later described such that business decisions or other decisions and actions may be made efficiently, quickly, and correctly by those who otherwise would not have understood the material presented without time-consuming explanations and analysis by the intellectual or patent experts.

In an embodiment, the present invention may be described a radar cross section, or circular graphic designated or divided into sectors, and concentric rings describing a layered description.

Disclosed are business methods, methods, systems, or apparatuses that for displaying information. In one example embodiment, to business methods, methods, systems or apparatuses, to easily display and present patents and intellectual property, along with associated data, within a graphic representation, preferably in a circular graphic.

In one example embodiment, to business methods, methods, systems or apparatuses, to easily display and objects, wherein the objects represent a data point, such as a patent or asset, and wherein associated data is presented within a graphic representation, preferably in a circular graphic.

In an example embodiment, which may be combined with any other embodiments, the present invention presents the ability to take multiple data entries, of which may have many data points about the data entries, and quickly and easily organize, present and convey the information.

In an example embodiment, which may be combined with any other embodiments the data entries are individual patents, or other intellectual property pieces, such as trademarks, and the data points are data and information about the data entries of which may be dates, etc.

In an example embodiments, which may be combined with any other embodiments, a preferred embodiment may be such that the data entries may be patents, or other pieces of intellectual properties such as trademarks, foreign filings, applications, or any other documents or data points or other documents.

In an example embodiment, which may be combined with any other embodiments, each data entry, there may be any number or plurality of data points, of which may include, but are not limited to, application numbers, publication numbers, patent numbers, names, dates, titles, summaries, text, pictures, logos, inventor titles, assignees, or any other values or text which may describe the data entries and are worth noting or otherwise are may be important to those looking at the display. These data points may be shared between data points, or many be unique. As well as this, they may be indefinitely applicable, such as an application number, or may be able to expire, such as dates, of which may be changed over time. Any data point and entry, may be automatically or manually updated as time or applications change.

In an example embodiment, which may be combined with any other embodiments, the data points and data entries may be automatically or manually. In addition the information for the data points does not have to already exist but may at the time of the business methods, methods, systems or apparatuses be formulated or otherwise assigned. This for instance may be exampled by the patent application number already existing, but no art unit has been assigned, such that late an art unit may be filled in. It also may be exampled by the data points for the data entry may exist already, such as a patent number and filing date, but a category, not yet associated with the patent, such as the user deciding the patent or data entry of question, along with its data points, are to be summarized as “important.” Thus a new data point then may be made for the “important” classification. In an embodiment then the user may then create data points and entries, not yet in existence or applied within the source materials. In some embodiments, these may be a categorization or subset grouping of the data entries or data points.

In an example embodiments, which may be combined with any other embodiments, the aforementioned data points and data entries may be procured by a single user or multiple users and may be stored in any file format, system, or database of which may include transitory or non-transitory medium as well as persistent data.

In some embodiments, which may be combined with any other embodiment, the present invention may provide wherein a business method, method, system or apparatus which may provide an ability for displaying a portfolio of discrete information points in one or more fields, such as the patent or intellectual property field.

In some embodiments, which may be combined with any other embodiment, the present invention such as the portfolio display may provide wherein creating or entering one or more first layer data entries in the portfolio.

In some embodiments, which may be combined with any other embodiment, the present invention may provide wherein the first layer data entries are the discrete information points. These discrete points may be patents or intellectual property pieces.

In some embodiments, which may be combined with any other embodiment, the present invention may provide wherein creating a diagram.

In some embodiments, which may be combined with any other embodiment, the present invention may provide wherein creating a diagram including at least one or more entry designators.

In some embodiments, which may be combined with any other embodiment, the present invention may provide wherein creating a diagram including at least one or more entry designators wherein the entry designators are assigned to a first layer data entry such as a patent. It is noted that the entry designators may be circular in shape on the chart or diagram and may include a value designator, which is assigned to the first layer data entry.

In some embodiments, which may be combined with any other embodiment, the present invention may provide wherein one or more category division are created.

In some embodiments, which may be combined with any other embodiment, the present invention may provide wherein one or more category division are created wherein the categories include one, one or more, or no first layer data entries, and may be dependent on the data entry itself. For instance by status, date, application type etc.

In some embodiments, which may be combined with any other embodiment, the present invention provides wherein the diagram includes a key for individual or groups of first layer data points by category division or type division.

In some embodiments, which may be combined with any other embodiment, the present invention may provide wherein one or more category division are divided on the chart by sector.

In some embodiments, which may be combined with any other embodiment, the present invention may provide wherein one or more category division are divided on the chart by sector and assigning and placing each first layer data entry a category division;

In some embodiments, which may be combined with any other embodiment, the present invention may provide by creating one or more breadth divisions.

In some embodiments, which may be combined with any other embodiment, the present invention may provide by creating one or more breadth divisions wherein one, one or more, or no first layer data points are assigned to a breadth division.

In some embodiments, which may be combined with any other embodiment, the present invention may provide by creating one or more breadth divisions and dividing them on the chart wherein also placing a first layer data entry via the breadth division respectfully for the data point. In some embodiments, which may be combined with any other embodiment, the present invention may provide by creating one or more breadth divisions and dividing them on the chart concentrically.

In some embodiments, which may be combined with any other embodiment, the present invention may provide by creating one or more type divisions.

In some embodiments, which may be combined with any other embodiment, the present invention may provide by creating one or more type divisions wherein one, one or more, or no first layer data points are assigned to a type division.

In some embodiments, which may be combined with any other embodiment, the present invention may provide by creating one or more type divisions and dividing them on the chart by sector, wherein also placing a first layer data entry via the type division respectfully for the data point.

In some embodiments, which may be combined with any other embodiment, the present invention may provide wherein creating a chart to display the detailed information of each or groups of first layer data entries or points.

In some embodiments, which may be combined with any other embodiment, the present invention may provide wherein creating a chart to display the detailed information of each or groups of first layer data entries or points wherein displaying each first layer data entry in a unique row.

In some embodiments, which may be combined with any other embodiment, the present invention may provide wherein creating a chart to display the detailed information of each or groups of first layer data entries or points wherein displaying each first layer data entry in a unique row.

In some embodiments, which may be combined with any other embodiment, the present invention may provide wherein creating a chart to display the detailed information of each or groups of first layer data entries or points wherein displaying each first layer data entry in a unique row wherein the column displays the respective entry designator information across the columns.

In some embodiments, which may be combined with any other embodiment, the present invention provides wherein the breadth divisions are relative broadness levels of the discrete data points to the portfolio as a whole. This is noted to be relative, subjective or objective to the field, patent, portfolio, etc. and can be arbitrary or defined mathematically, statistically, or by any other method.

In some embodiments, which may be combined with any other embodiment, the present invention provides wherein the broadness of the discrete data points defined by the breadth divisions which are concentrically arranged breadth divisions on the diagram.

In some embodiments, which may be combined with any other embodiment, the present invention provides wherein the broadness of the discrete data points defined by the breadth divisions which are concentrically arranged breadth divisions on the diagram and which may include at least, in addition, or with other divisions: core level, system level, and peripheral level.

It is noted that core level can be defined to be a data point at the core or inherent importance to the portfolio, such as centralized or key, or important patent that protects the application as a whole. This can for instance be a patent that describes the structure of a chair for instance.

It is noted that system level can be defined to be a data point for the system level of importance to the portfolio, such as system level or important patent that protects the system level of the invention. This can for instance be a patent that describes the method of use for the chair with a table.

It is noted that peripheral level can be defined to be a data point for the system level of importance to the portfolio, such as a peripheral or either broader related application or otherwise related patent that protects a use, embodiment, or other part of the invention This can for instance be a patent that describes the protectors for the bottom of the chair so that the chair does not scrape hardwood floors.

It is noted that the breadth, as well as any other divisions can have any plurality of categories, types, and breadths such that the data points re easily understood in relation to the category, type, breadth, or division.

In some embodiments, which may be combined with any other embodiment, the present invention provides wherein the category divisions are unique to the portfolio and commerce space.

In some embodiments, which may be combined with any other embodiment, the present invention provides wherein each type division and associated first layer data points are assigned a color, wherein the color is displayed on the chart and diagram in the entry designator. This color may also be a shade, texture or other display property such that is easily identifiable between the chart and display.

In some embodiments, which may be combined with any other embodiment, the present invention provides wherein the user may draw one or more arrows.

In some embodiments, which may be combined with any other embodiment, the present invention provides wherein the user may draw one or more arrows wherein an arrow is drawn to indicate gaps in the coverage of the first layer data entries in the category divisions.

In some embodiments, which may be combined with any other embodiment, the present invention provides wherein the user may draw one or more arrows wherein an arrow is drawn to indicate gaps in the coverage of the first layer data entries in the breadth divisions.

In some embodiments, which may be combined with any other embodiment, the present invention provides wherein the user may draw one or more arrows wherein an arrow is drawn to indicate gaps in the coverage of the first layer data entries in the category and breadth divisions.

In some embodiments, which may be combined with any other embodiment, the present invention provides wherein the user may draw one or more arrows wherein an arrow is drawn to indicate gaps in the coverage of the first layer data entries such that wherein the arrows indicate where a competitor can enter the field.

In some embodiments, which may be combined with any other embodiment, the present invention provides wherein the user may draw one or more arrows wherein an arrow is drawn to indicate gaps in the coverage of the first layer data entries such that wherein the arrows provide an easy to understand display to understand where a competitor can enter the field.

In some embodiments, which may be combined with any other embodiment, the present invention provides wherein the user may draw one or more arrows wherein an arrow is drawn to indicate gaps in the coverage of the first layer data entries such that wherein the arrows provide an easy to understand display to understand where to file future patents or data points.

In some embodiments, which may be combined with any other embodiment, the present invention provides wherein the user may draw one or more arrows wherein an arrow is drawn to indicate gaps in the coverage of the first layer data entries such that wherein the arrows provide an easy to understand display to understand where to file future patents or data points and wherein the arrows are marked to a corresponding chart which indicates details of the future filings.

In some embodiments, which may be combined with any other embodiment, the present invention provides wherein the user may enter one or more additional new first layer data point in the chart and diagram, wherein the new first layer data point is a proposal, such as in a proposal chart or page.

In some embodiments, which may be combined with any other embodiment, the present invention provides wherein the user may enter one or more additional new first layer data point in the chart and diagram, wherein the new first layer data point is a proposal, such as in a where the proposals have their own category, color, designator, etc.

In some embodiments, which may be combined with any other embodiment, the present invention provides wherein the chart additionally includes wherein each first layer data entry in its row includes at least the columns for docket, family, or case number, one or more patent, application or official number, one or more date columns, wherein one is a filing date, status, and official or unofficial title.

It is noted that the chart, diagram, and any other charts, diagrams, text boxes or indicators may be on the same page or display ,screens, separate, or any combination such as side by side.

In some embodiments, which may be combined with any other embodiment, the present invention provides wherein a second chart is created, wherein the second chart includes: the entry designator for the displayed first layer data entry, a docket, family or case number, a title, and a detailed description.

It is noted that the above titles, descriptions, categories, etc. are purely for example, and may be any other type, indicators in patents, or any other field for which the data points exist within.

It is noted that any plurality of charts and diagrams may be made, such as by category, specific field or any other applications. For instance, the present invention may provide wherein creating a third chart, wherein the third chart includes proposals for future actions such as wherein the future actions are patents to be filed.

It is specially noted that the data point and data entries may be found in a patent or intellectual search, of which may have already been performed for other uses, or may specifically be performed for the creation of this invention

In an example embodiment, which may be combined with any other embodiments, the aforementioned information, data points and data entries gathered may be presented or organized in a spreadsheet, chart or other business methods, methods, systems or apparatuses for analyzation such as an Excel sheet, where the information then is organized. Specific data points gathered may be presented in columns or lines, such as vertically or horizontally with each data entry. It is noted that it can be obvious that there will be other business methods, methods, systems or apparatuses of storing or organizing the data, of which may include a UI interface, or other simple spreadsheet or document style designs.

In an example embodiment, which may be combined with any other embodiments, the user may then analyze the data points and data entries.

In an example embodiment, which may be combined with any other embodiments, the user may then create categories or special categorization, of which may be a value, such as a text or name, such as a category, or may be a color, or number may be assigned as well as any other special designation.

In an example embodiment, which may be combined with any other embodiments, each data entry may also be given a designator, such as a value, color or shape. As well as this any number of designators may be assigned, and may be different in scope as well as be shared between data entries or data points. These categorizations and designators may be due to the analyzation and judgement of the user, or may simply be based on a value or presence of a data point or data entry. An example may be “Patent 1” may be given an individual designator “1” and also group designator color “green” for “current patent”. Patent2 may be given a designator “2” and also designator color “yellow” for “expiring patent” etc.

In an example embodiment, which may be combined with any other embodiments, there may be a circular graph.

In an example embodiment, which may be combined with any other embodiments, there may be a circular graph representing the 360 view.

In an example embodiment, which may be combined with any other embodiments, there may be a circular graph designated as the “360” view.

In an example embodiment, which may be combined with any other embodiments, there may be a circular graph designated as the “360 degree” view.

In an example embodiment, which may be combined with any other embodiments, there may be a circular graph designated as the “360° ” view.

In an example embodiment, which may be combined with any other embodiments, there may be a circular graph representing the 360 view. Wherein then the aforementioned data points and data entries spreadsheet then links to the 360 view.

In an example embodiment, which may be combined with any other embodiments, there may be a circular graph representing the 360 view. Wherein then the aforementioned data points and data entries spreadsheet then links to the 360 view automatically or manually, such as based on values of the data points and entries. In some embodiments, this is down automatically such as through a computer algorithm, but in a preferred embodiment is performed by the user based on the analyzation and expertise.

In an example embodiment, which may be combined with any other embodiments, there may be a circular graph representing the 360 view., wherein the aforementioned spreadsheet or data points and entries, may be on a different page, or appreciable on the same page or screen of the presentation, dependent on the format, screen size or any other reason, and can even be a subset of the same page. In a preferred embodiment, the 360 display may be the first page which is the main display with the 360 chart.

In an example embodiment, which may be combined with any other embodiments, the 360 chart may be described as circular.

In an example embodiment, which may be combined with any other embodiments, the 360 chart may be described as circular with circular rings of any plurality radially from the center of the circle. In some embodiments, there may be horizontal, vertical or diagonal lines of any plurality intersecting in the center of the circle, or any other place. An example may be that the 360 display looks much like a radar screen with cross sections.

In an example embodiment, which may be combined with any other embodiments, it is noted that any text, lines, shading, background or other features may be any point size, thickness, shade, color, texture or picture, such as either for designation or other reasons such as to bold or make clear a point of important, or stylistic such as to match company colors.

In an example embodiment, which may be combined with any other embodiments, any plurality of categories may be presented in a quadrant or other division of the circle. In an example embodiment these categories may be horizontally placed such as to designate rings radially out from the center of the structure as zones, or may not match the rings and may be designator zones. The zones and categories may be shaded, colored, numbers or any other aspect.

It is noted that the categories may be obviously specific to less specific, as they radiate out from the center, or conversely may be less specific to specific, or may be any other designation or relation, whether casually related, or not related at all but separate distinct categories.

In an example embodiment, which may be combined with any other embodiments, the data entry then with a value, shape or color designator such as blue circle with a number 1 within the blue circle may then be placed in each quadrant, such that the data entry may be seen to be within each category by the designator. In addition to designators for each quadrant there may be any other plurality of designators or sub quadrants, that may be less or more specific than the first mentioned designators, but also be of a different plane or scale than the first or other designations categories. For example, the blue designator may mean the entry is an allowed, patent, the circle may be it is a patent with Applicant A, and the circle may be it was bought prior to 2002, for example. This allows then the 360 chart to display more than simply a single designation but provide for more degrees and types of categorizations simultaneously. This may then allow the chart to be efficient in displaying many different data points for many different data entries in different scopes.

In an example embodiment, which may be combined with any other embodiments, it is noted that the designators may be listed in short form, or any form, along with any other data entry or data point in a title box, or keyword box on the same page or in proximity to the 360 chart such that it may easily be compared or read with the chart.

In an example embodiment, which may be combined with any other embodiments, an additional categorization may be categories or designator titles radially spaced around the circle. These such then may be based on the values or titles of the data entries or data points. In addition these categories radially space may be separated by vertical, horizontal or diagonal liens, but also may be standalone. In addition these radial categories can able to present mixture of each category, such as if a data entry designator is between two radial categories, then it can easily be seen that the designator entry may share the two descriptions, or if the designator closer to one radial category, and slightly further than another may be then mostly one category or description and less than another.

The business method, method, system or apparatus and systems disclosed herein may be implemented in any means for achieving various aspects. Other features will be apparent from the accompanying drawings and from the detailed description that follows.

Although the present embodiments have been described with reference to specific example embodiments, it will be evident that various modifications and changes may be made to these embodiments without departing from the broader spirit and scope of the various embodiments. It should be understood by one of ordinary skill in the art that the terms describing processes, products, elements, or business method, method, system or apparatus are industry terms and may refer to similar alternatives In addition, the components shown in the figures, their connections, couples, and relationships, and their functions, are meant to be exemplary only, and are not meant to limit the embodiments described herein.

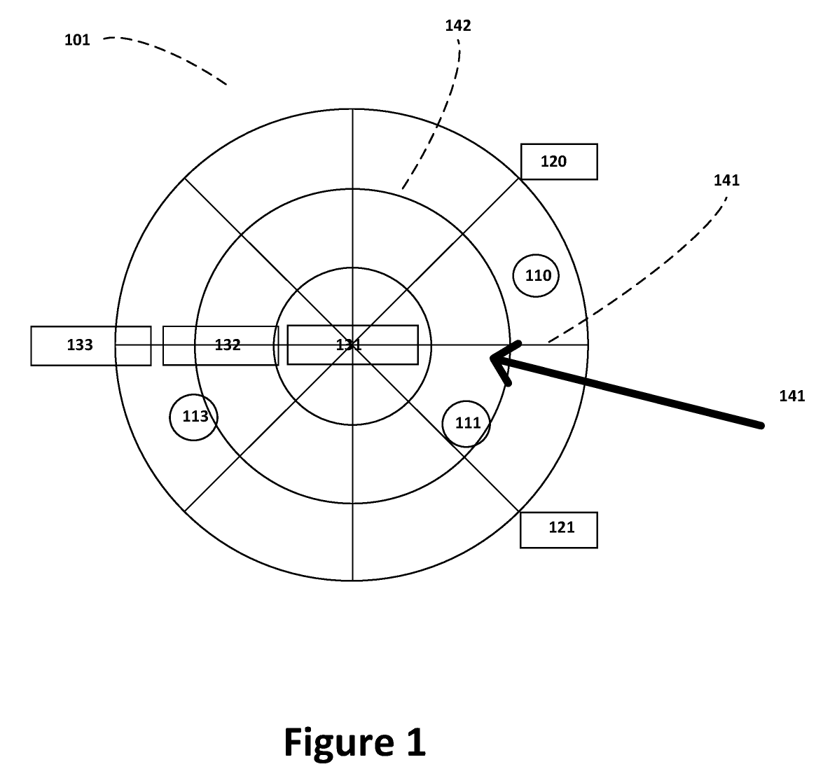

FIG. 1 is a simple depiction of the present invention solely an example 360 diagram according to some embodiments. Depicted as an example embodiment is the 101 360 diagram. The 360 diagram may include entry designator 110, of which may be a designator of any shape, such as a circle, any colour, and of which may have a value designator within such as a number. These entry designators may correspond to a specific data entry or multiple data entries with any data points. The designator may then be placed anywhere in the circle, such as the designator 110 and designator 111. Category designators 120 and 121 may then designate quadrants of any plurality around the ring. Category Designators may correspond to diagonal, horizontal or vertical quadrant line such as lines 141, but also do not necessarily have to or be depicted. The entry designators 110 and 111 may then correspond by placement to the category designators 1120 and 121 such that the features or facts of the category designators may be applied to the entry designators and then data entries and data points by those categories. For example, because entry designator 110 is close or in the same quadrant as category designator 120, then the data entry 110 may then be thought of to be very close to the characteristics or descriptions of category 120. Also, because entry designator is somewhat between, such as 80% closer to category 120, but 20 percent close to 121, then the data entry 110, can be thought of to share in a proportion of the characteristics of the category 120 and 121 respectively. For data designator 111, because it is closer to category designator 121, then the data entry 111 can be thought of mostly to have the characteristics of 121 but also some of 120 proportionally based on perceived distance. For data entry 113 shown by designator 113, because the designator is not substantially close to category designator 120 or 121, it can be said seen it has none or very limited characterizations of 120 or 121 categories. It is noted that in some cases, it is difficult to with many categories and designator to place the designators in all applicable categories or judgment or some other algorithm places the designator in the best relationship, even if it is not perfect or ideal. In addition there may be radial category designators 131, 132, and 133, of which may be a separate category designation system such that radially spans from the centre of the circle. For instance entry designator 110 and 113 are in the same radial sphere of 133, and as such may be seen to align with the categories 133, with entry 113 being somewhat closed to the radial of 132, and as such may share a little closer or proportional categorization of 113 and 132 than 131. Entry Designator 111 may then be seen to share Category 132 characteristic more than 113 and 110 being further closer to the radial designation of category 132.

In some embodiments, line 141 may designate area where the user designates the portfolio and data entries as each. For instance Line 141 can visually depict that where the cross section of category 120 and 121 meet, there is a scope of an invention or category where the existing data entry 110 and 111 do not protect against and as such a competitor may be able to attack the intellectual property of the present company from. This may be useful to show visually, and explain visually where data entry congregations, such as in an intellectual property portfolio or are weak or need further protection. Of note some data entries and data points, may not be patents or application, yet, but may also be proposed patents, application, along with entries, such as title, subjects, categories data, etc. to be files, such as to protect from an attack, etc.

It is noted that many of the features in different embodiments, may be missing or left out purposely, such as the radial lines do not necessarily have to be depicted in some embodiments due to complexity limitations, drawing limitations or any other reason including applicability.

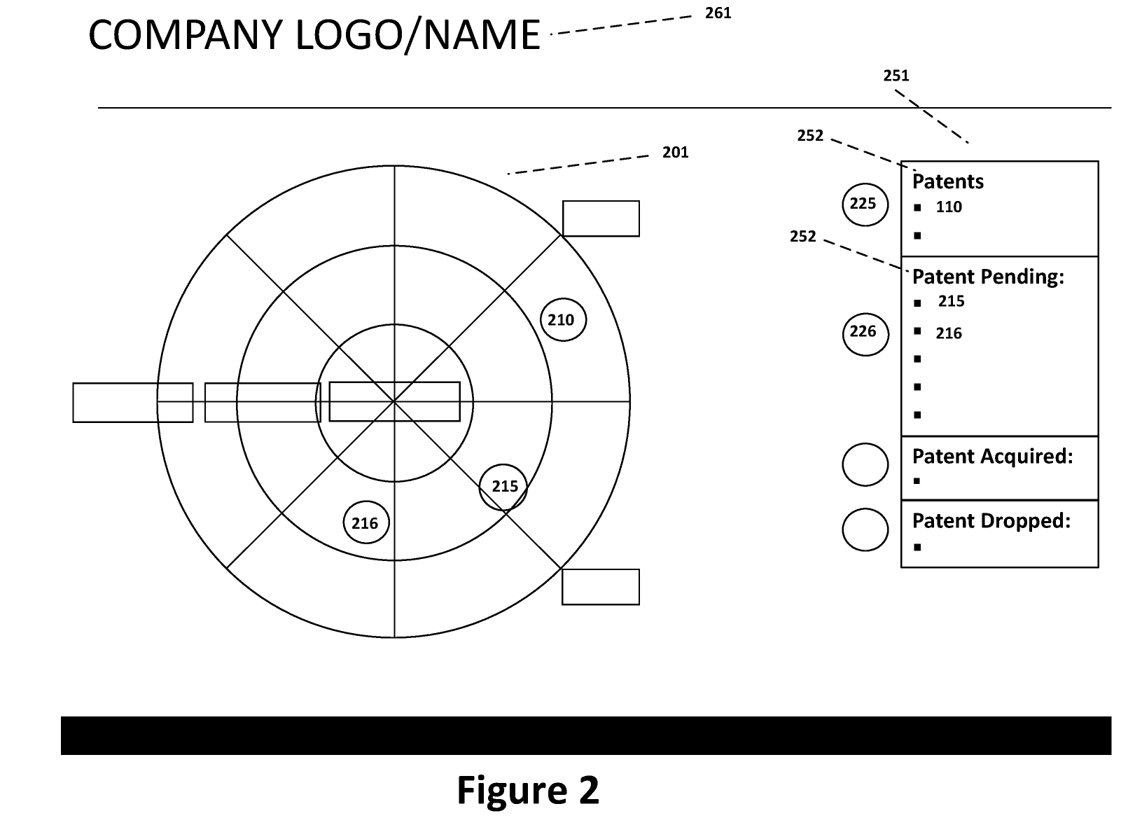

FIG. 2 is a depiction of the present invention 360 diagram with presentation layout according to some embodiments.

FIG. 2 presents the 360 diagram 201 on an example slide, with descriptors or other elements 261, for example which may be logos, company names, etc., and also a descriptor box 251, which may describe the data designators, data entries, and additional data points or data entries. The box 251 may include intermediary titles 252, of which may be separated, and as much may be an example a title of “patents”. These titles may include multiple data entries, such as data entries 210 under title 252 and data entries 215 and 216 under Title 253. These data titles and groups may then correspond to colors, or other designs such as Data entries 210 listed by title in the descriptor box, and having a corresponding colored and numbered designator 225, showing up on the chart as designator 210, of which is a matching color, while data entries 215 and 216 having designator example 226 of a certain color, shape or design matching to their designators on the diagram 215 and 216. It is noted that the descriptor may have any title or data, and may include any of the objects such that the chart and diagram is easy to follow, and readable.

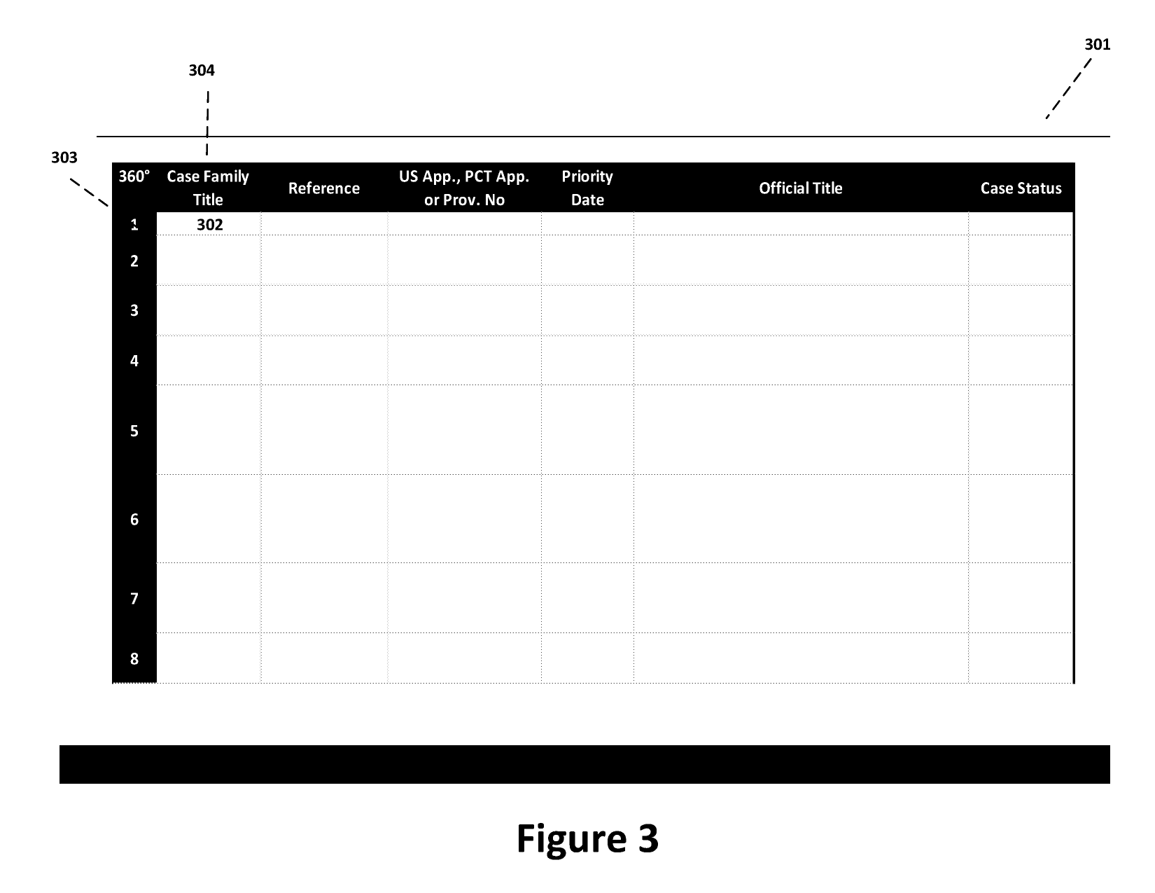

FIG. 3 is a simple depiction an example spreadsheet list of data points presented on 360 diagram according to some embodiments.

The Chart 101 may then list the individual data entry, such as by row with a designator number or value, color or other characteristic 303, of which may match with the designator or at least designator box as seen in FIGS. 1 and 2, such that one can easily connect the row of the chart and data entry to the designator on the diagram and designator box., The sheet may then further include further data entry categories 304 across the top such that data points 302 about each data entry 303 may be easily understood and associated. It is noted that the chart may be of any other format, and may be switch horizontally and vertically, and any plurality of categories or data points and entries may be noted, including any style, text, format, color or shapes of which may or may not match with the diagram as well may be for any use.

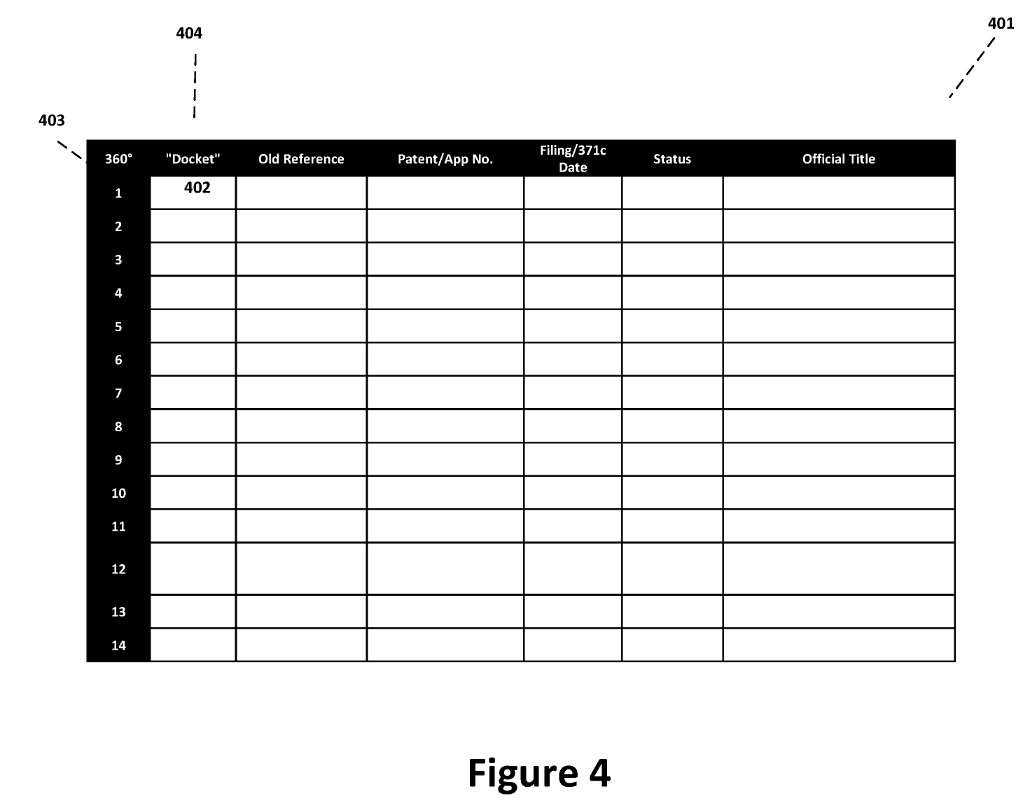

FIG. 4 is a simple depiction an alternate example spreadsheet list of data points presented on 360 diagram according to some embodiments.

FIG. 4 described at least a chart 301 wherein includes a designator column 403, docket column 404 with entries 402. Additionally, it is noted that any the columns may include any number of titles and information.

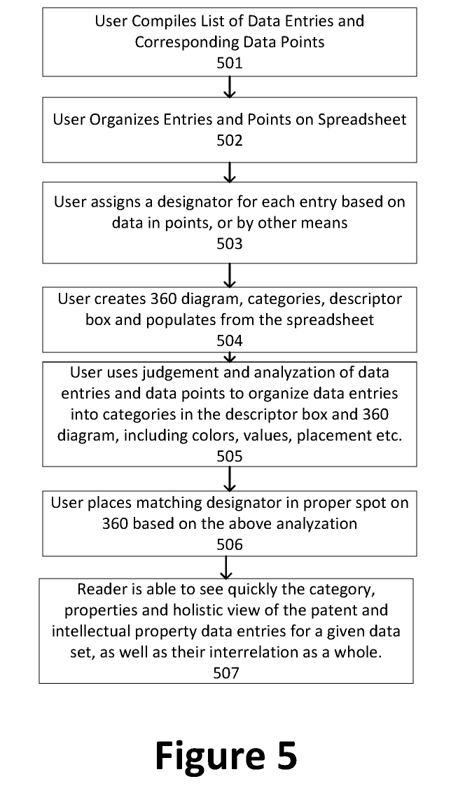

FIG. 5 is an example process for creating a 360 diagram according to some embodiments. Process 501 includes the user compiling a List of Data Entries and Corresponding Data Points. It is noted this may be done from any source, or prior works etc. Process 502 includes then the User Organizes Entries and Points on Spreadsheet such that the data entries and points are categorized and readable. Process 503 includes at least the user assigns a designator for each entry based on data in points, or by other means, such as a number or value to associate the entry with the data points if one is viewing the 360. Process 504 includes the User creates 360 diagram, categories, descriptor box and populates from the spreadsheet or using it from a template, etc. Process 505, then using expertise and judgment as well as analyzation of data entries and data points to organize data entries into categories in the descriptor box and 360 diagram, including colors, values, placement etc. such that they may be easily presented and applied, as well as understand the scope of the patents and intellectual property. Process 506 includes at least the User places matching designator in proper spot on 360 based on the above analyzation such that the designator is placed in any proper categories, and proper designator color, shape, etc. Process 507 then has the reader or view with the ability to see quickly the category, properties and holistic view of the patent and intellectual property data entries for a given data set, as well as their interrelation as a whole.

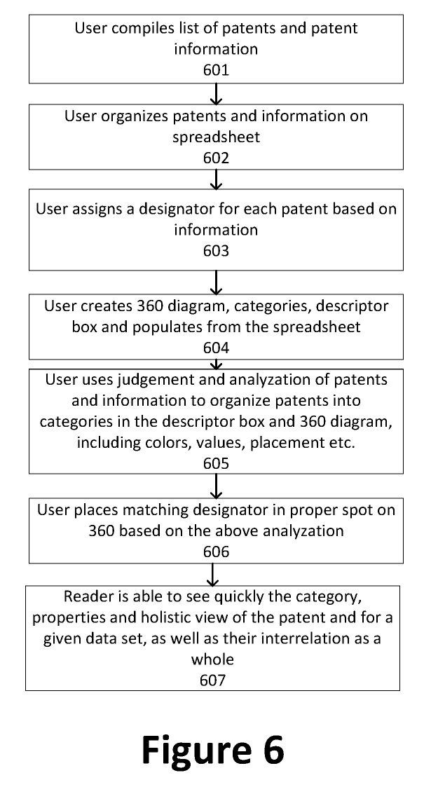

FIG. 6 is an example alternate process for creating a 360 diagram according to some embodiments that are specific to intellectual property and patents.

FIG. 6 describes at least a business methods, methods, systems or apparatuses which includes process 601 which includes at least wherein the user compiles list of patents and patent information, process 602 which includes at least User organizes patents and information on spreadsheet, process 603 which includes at least User assigns a designator for each patent based on information, process 604 which includes at least where the user creates 360 diagram, categories, descriptor box and populates from the spreadsheet, process 605 which includes at least wherein the user uses judgement and analyzation of patents and information to organize patents into categories in the descriptor box and 360 diagram, including colors, values, placement etc., process 606 which includes at least wherein the user places matching designator in proper spot on 360 based on the above analyzation, process 607 which includes at least wherein the reader is able to see quickly the category, properties and holistic view of the patent and for a given data set, as well as their interrelation as a whole.

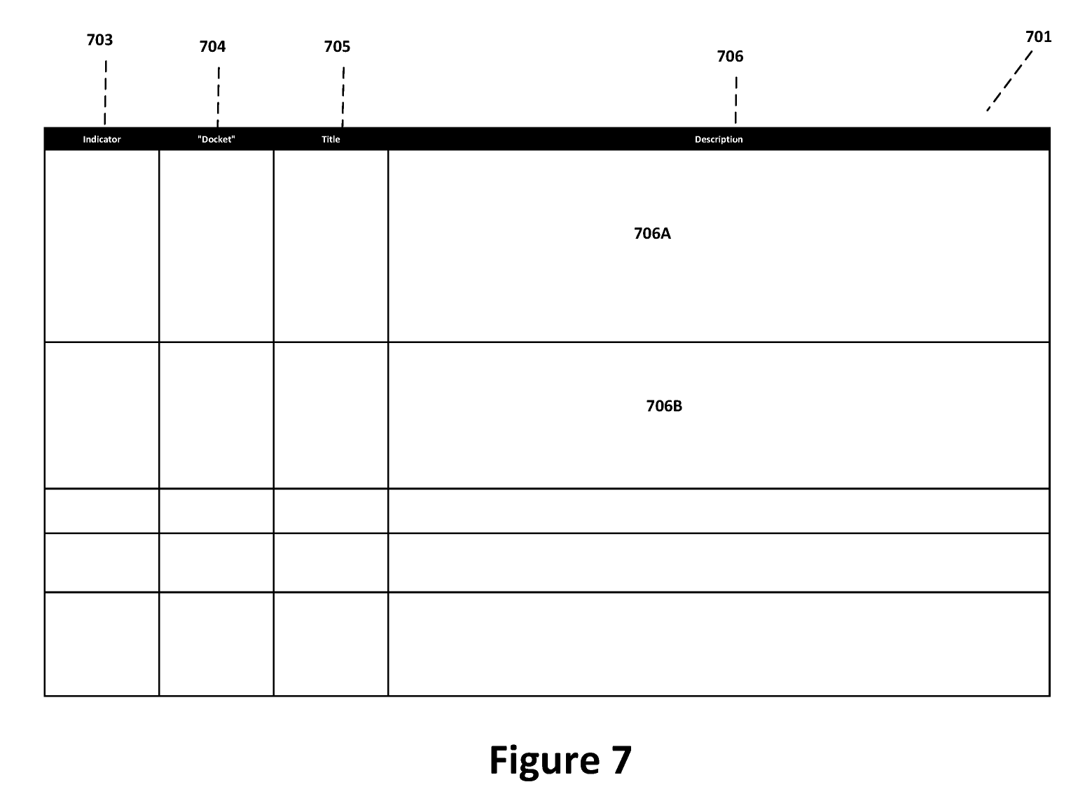

FIG. 7 is an example spreadsheet list of data points with description area presented on 360 diagram according to some embodiments.

FIG. 7 describes a chart which includes a description area, wherein an indicator 703 may indicate the column for each individual data point, and then also rows for instance for docket numbering 704, title 706, and a detailed description 706. It is noted that the areas for the rows, and columns may be adjusted in size to fit the information to be presented as can be seen in different size block 706A and 706B, among others.

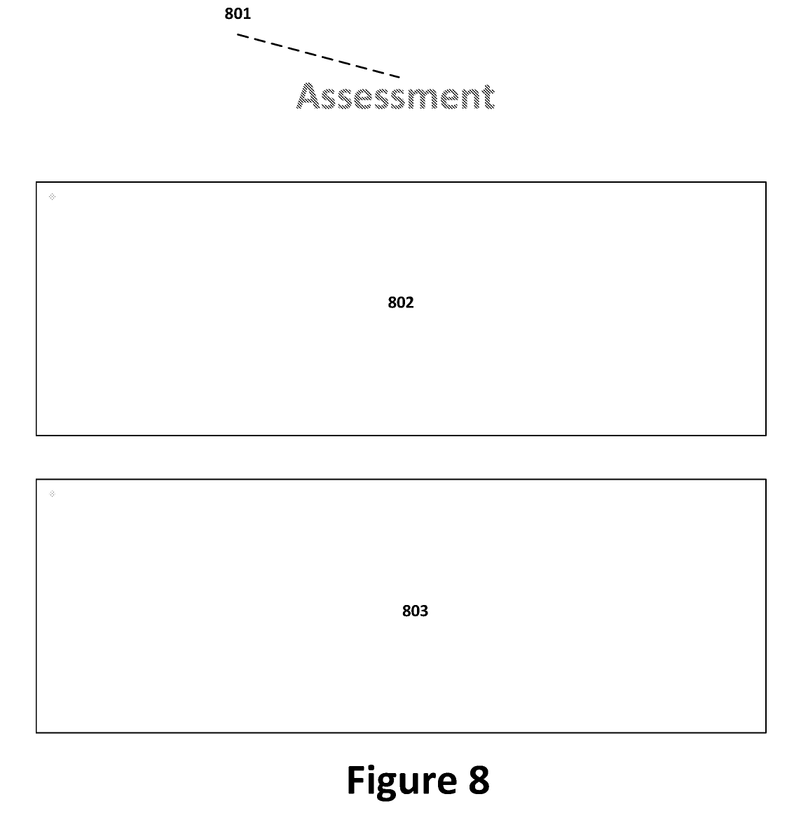

FIG. 8 is an example assessment description area presented on 360 diagram according to some embodiments.

FIG. 8 describes an additional page wherein an assessment by the user may be described with title 801, and text boxes 802 and 803 wherein the text boxes may be adjusted for size and may include images as well as text.

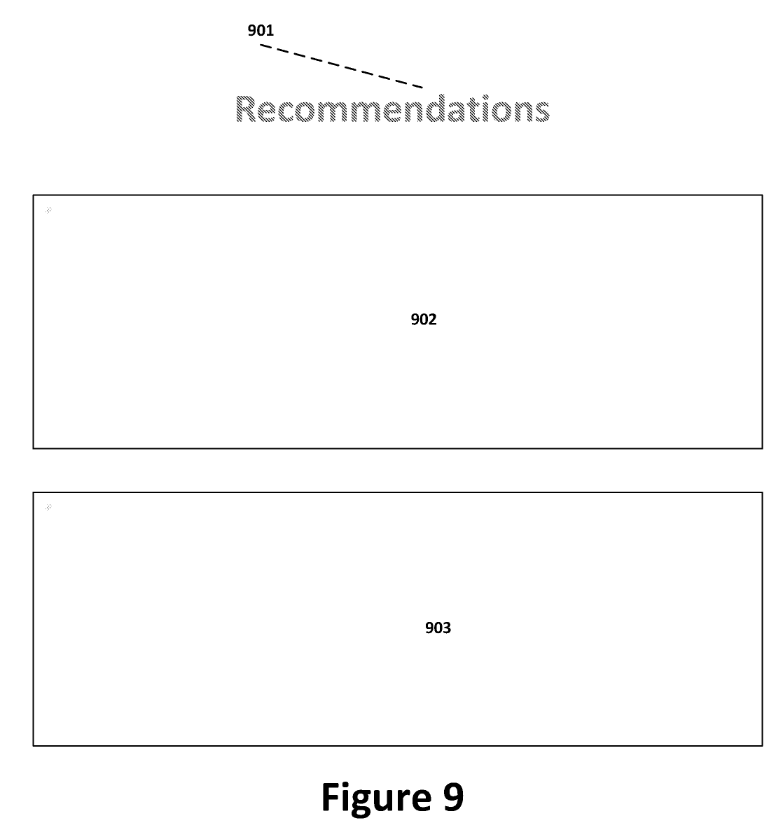

FIG. 9 is an example recommendation description area presented on 360 diagram according to some embodiments.

FIG. 9 describes an additional page wherein recommendations by the user may be described with title 901, and text boxes 902 and 903 wherein the text boxes may be adjusted for size and may include images as well as text.

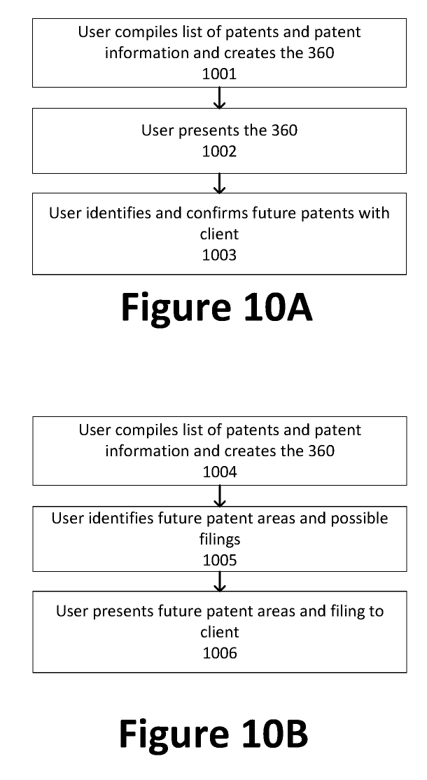

FIG. 10A is an example process for creating a 360 diagram according to some embodiments.

FIG. 10A describes at least process 1001 wherein at least the user compiles list of patents and patent information and creates the 360, process 1002 wherein at least the user presents the 360, process 1003 wherein at least the user identifies and confirms future patents with client.

FIG. 10B is an example process for creating a 360 diagram according to some embodiments.

FIG. 10B describes at least process 1004 wherein at least the user compiles list of patents and patent information and creates the 360, process 1005 wherein at least the user identifies future patent areas and possible filings , process 1006 wherein at least the user presents future patent areas and filing to client.

It is noted that any process may be enacted by either a person, people or team, or a computer, software, or AI at any level, and in any combination or for any reason.

A preferred embodiment then has a patent expert, or someone familiar in intellectual property, or the capacity to make judgement calls. From this the person, has a compiled list of the data entries or patents and patent application, and then compiles them on a spreadsheet where then the person chooses data points to organize with each data entry patent. From these data points and data entries, the user expert is able to formulate categories and apply them within the 360 graph base on the categories both in either radial groups and vertical, horizontal and diagonal grouping categories. It is noted that these categories may be such as fields of the inventions, but also the strength of meaning of the patent or intellectual property such as most important as seen in FIG. 1, where Category 131 may be “Core”, Category 132 may be “Application” and category 133 may be “Peripheral” to point at the applicability and place of each piece of data entry. From there, the user may then analyze the patents, and due to the construction of the 360, the amount and plurality as well as complexity of the data entries and points because easier to follow, and educated decisions and views on the portfolio of data entries, patents may be made and summarized to associates and colleagues. As well as this, this may provide then proof, or efficient way to describe the points of the intellectual property portfolio as described by the data entries. Then this invention provides an ability for an intellectual property expert to convey knowledge not easily described before due to the plurality and complexity of data points and entries, such as patents, both for their own understanding and benefit, but also for clients and businesses. The 360 may then provide an overview and structure to complete and assess business's IP portfolio, and more than that their strengths and weaknesses.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, business method, method, system or apparatus, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method for displaying a portfolio of discrete information points, in one or more fields,
comprising of at least one of the following:
entering one or more first layer data entries in the portfolio:
wherein the first layer data entries are the discrete information points;
creating a diagram including at least displaying:
one or more entry designators, wherein:
assigning each first layer data entry an entry designator;
one or more category division divided on the chart by sector, wherein:
assigning each first layer data entry a category division;
one or more breadth divisions dived on the chart concentrically:
assigning each first layer data entry a breadth division;
one or more type divisions:
assigning each first layer data entry to a type division;
creating a chart including wherein:
displaying each first layer data entry in a unique row, wherein:
each first layer data entry in its row includes at least a column to display the respective entry designator.

2. A method as in claim 1, additionally including:
wherein the first layer data entries are patents.

3. A method as in claim 1, additionally including:
wherein the entry designator is a circle.

4. A method as in claim 1, additionally including:
wherein the entry designator includes a value number that is unique to the data entry.

5. A method as in claim 1, additionally including:
wherein the diagram is a circular graphic.

6. A method as in claim 1, additionally including:
wherein the diagram resembles a radar style display.

7. A method as in claim 1, additionally including:
wherein the breadth divisions are relative broadness levels of the discrete data entries to the portfolio as a whole.

8. A method as in claim 7, additionally including:
wherein broadness of the discrete data entries are defined by one or more of the following concentrically arranged breadth divisions on the diagram:
core level,
system level, and
peripheral level.

9. A method as in claim 1, additionally including:
wherein the category divisions are unique to the portfolio and a commerce or technological space.

10. A method as in claim 1, additionally including:
wherein each type division and associated first layer data entries are assigned a color, wherein the color is displayed on the chart and diagram in the entry designator.

11. A method as in claim 1, additionally including:
drawing one or more arrows:
wherein an arrow is drawn to indicate gaps in the coverage of the first layer data entries in the category divisions and the breadth divisions.

12. A method as in claim 11, additionally including:
wherein the arrows indicate where a competitor can enter the field.

13. A method as in claim 9, additionally including:
entering one or more additional new first layer data entry in the chart and diagram, wherein the new first layer data entry is a proposal.

14. A method as in claim 1, additionally including:
wherein the diagram includes a key for individual or groups of first layer data entries by category division or type division.

15. A method as in claim 1, additionally including:
creating the chart additionally including:
each first layer data entry in its row includes at least the columns for:
docket, family, or case number,
one or more patent, application or official number,
one or more date columns, wherein one is a filing date,
status, and
official title.

16. A method as in claim 1, additionally including:
the chart and diagram are on separate pages.

17. A method as in claim 1, additionally including:
the chart and diagram are displayed side by side

18. A method as in claim 1, additionally including:
creating a second chart, wherein the second chart includes:
the entry designator for the displayed first layer data entry,
a docket, family or case number,
a title, and
a detailed description,

19. A method as in claim 1, additionally including
creating a third chart, wherein the third chart includes:
proposals for future actions.

20. A method as in claim 19, additionally including
wherein the future actions are patents to be filed.
